(19) United States
(12) Patent Application Publication
(10) Pub. No.: US 2015/0371273 A1
(43) Pub. Date: Dec. 24, 2015

(54) LOCATION BASED ADVERTISEMENT SYSTEM USING WI-FI

(71) Applicant: INTEL CORPORATION, Santa Clara, CA (US)

(72) Inventors: Necati CANPOLAT, Beaverton, OR (US); Myron P. HATTIG, Portland, OR (US)

(21) Appl. No.: 14/762,175

(22) PCT Filed: Feb. 20, 2014
(86) PCT No.: PCT/US2014/017405

§ 371 Date: Jul. 20, 2015

Related U.S. Application Data
(60) Provisional application No. 61/767,976, filed on Feb. 22, 2013.

(51) Int. Cl. G06Q 30/02

(52) U.S. Cl. CPC G06Q 30/0261; G06Q 30/0267

(57) ABSTRACT

A location based advertisement system is described. The system for providing location based advertisement services includes (i) a wireless device having a processor, a memory and one or more transceivers, the wireless device configured to send a query request to one or more access points (APs) explicitly specifying support for location based advertisement (LBA), (ii) one or more APs, each enabled to advertise LBA support, and configured to communicate with one or more wireless devices and one or more servers, and (iii) one or more servers providing LBA services, the one or more servers configured to communicate with the one or more APs. The system may further include a LBA access controller for connecting the one or more servers. LBA access controller, in some embodiments, may be a wireless or a wired router for routing LBA information data packets between server(s) and AP(s).

### CROSS-REFERENCE TO RELATED APPLICATION

The application claims priority from U.S. Provisional Application No. 61/767,976, filed Feb. 22, 2013, which is incorporated herein by reference.

### TECHNICAL FIELD

This disclosure relates generally to location based services, and in particular, to indoor location based and venue based services as well as systems and methods to implement such services.

### BACKGROUND ART

Location based advertising refers to marketer-controlled information specially tailored for the location where a user is accessing the advertising medium. Such advertising can be useful in guiding customers in their shopping experience, e.g., at shopping malls, airports, stadiums, retail stores and the like. For example, a retail store at a shopping mall may provide coupons to customers walking by their stores in the mall on their mobile devices. Likewise, large stores such as Home Depot or Wal-Mart may be able to guide their customers to the appropriate aisle when looking for specific goods.

Current implementations of location based advertising on mobile devices are enabled using Global Positioning System (GPS) or cellular networks. However, both these technologies have limitations in indoor settings: GPS is not available, and cellular range does not have sufficiently small granularity to provide accurate location information. Better implementation of location based advertising is, therefore, desired.

### BRIEF DESCRIPTION OF THE DRAWINGS

FIG. 1 depicts a schematic of an example of a process presently available for obtaining venue based advertisement.

FIG. 2 depicts an illustrative schematic of an embodiment of a location based advertisement system in accordance with various aspects and principles of the present disclosure.

FIG. 3 depicts an illustrative message flow diagram in an embodiment of location based advertisement system in accordance with various aspects and principles of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

In accordance with various embodiments of this disclosure, what is disclosed is a wireless device (STA) that includes a processor, a memory, and one or more transceivers, the STA configured to send a query request to one or more access points (APs) explicitly specifying support for location based advertisement (LBA). The STA is adapted to support a protocol that supports a pre-association or a post-association exchange of frames.

In accordance with various embodiments of this disclosure, further disclosed is a system that includes a wireless device (STA) including a processor, a memory and one or more transceivers, the STA configured to send a query request to one or more access points (APs) explicitly specifying support for location based advertisement (LBA). The system further includes one or more APs, each enabled to advertise LBA support, and configured to communicate with one or more STAs and one or more servers, and one or more servers providing LBA services, the one or more servers configured to communicate with the one or more APs.

In accordance with the various embodiments of the present disclosure, still further disclosed is a method of implementing location based advertisement (LBA) services. The method, in an embodiment, includes initiating discovery between a wireless device (STA) and an access point (AP) to identify support for location based advertisement (LBA) services, transmitting, from the STA, a query request for LBA information to the AP using pre-association exchange frames, relaying the query request to a LBA server, and analyzing, at the server, the query request. The STA includes a processor, a memory, and one or more transceivers, and is configured to send a query request to one or more access points (APs) explicitly specifying support for location based advertisement (LBA).

Location based advertisement (LBA) services can be, generally, categorized into two types: push-type and pull-type. In push-type LBA services, an advertiser sends or “pushes” LBA information to a consumer. This can be done as an opt-out or an opt-in service depending on whether the consumer has or has not voluntarily requested for such information. The push-type approach is more versatile in allowing advertisers to target consumers with LBA information, but has a potential to be a nuisance to the consumer if not used with appropriate care. In general, advertisers using push-type services are required to follow certain regulations.

On the other hand, pull-type LBA services allow the consumer to look for location based information on their own and is offered an advertisement service accompanying the relevant information. For example, a user searching for the nearest local Indian restaurant may be provided a discount coupon for a particular Indian restaurant within the search radius along with location information of that restaurant on a map.

Mobile device users are often interested in discovering what is nearby and exploring them conveniently. Currently, there are some location based services enabled on mobile devices using GSP and cellular networks. But they have significant limitations in indoor use cases where GPS is not available or the granularity of cellular range is too large. When a user sees an offer that is three miles away, it is less tempting than an offer that is only 50 yards away, which is a good range for wireless networks based on WiFi.

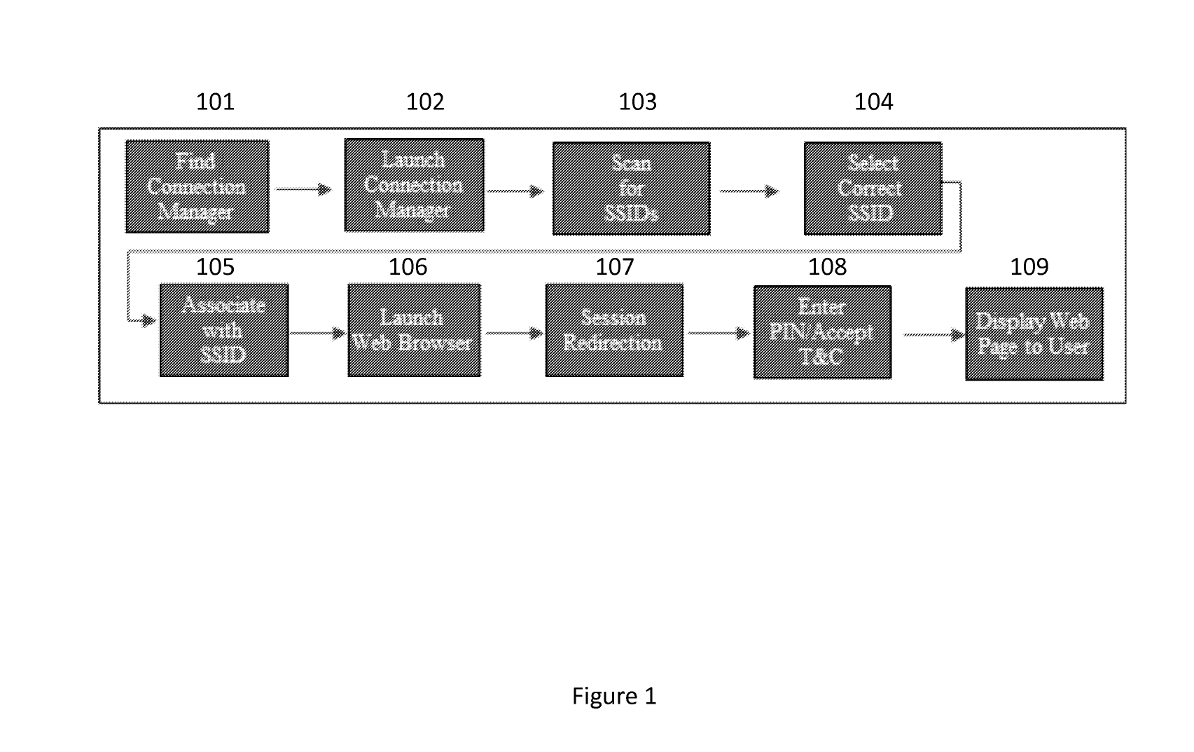

As such, WiFi may enable proximity based indoor LBA services. A business may provide cost free internet access through WiFi to consumers and advertise its services over the WiFi network while the consumers access internet. However, this requires the users to associate their mobile device with the WiFi network. As such, WiFi based advertisement presently requires manual involvement of users in multiple steps as shown in FIG. 1.

In FIG. 1, the process involves finding the connection manager on their mobile device 101, launching the connection manager 102, scanning for available WiFi networks (service set identifiers or SSIDs) 103, selecting the SSID of the business 104, associating the mobile device with the selected SSID 105, launching a web browser on the mobile device 106 followed by session redirection 107 and/or entry 108 of a passphrase and/or accepting terms of use before the actual content may be displayed 109. This cumbersome process deters consumers from using it and limits the businesses' ability to advertise their services.

Embodiments disclosed herein build on a widely available WiFi technology, Institute of Electrical and Electronics Engineers' (IEEE's) 802.11u standard (hereinafter “IEEE 802.11u”) called “Generic Advertisement Service (GAS) frames.” IEEE 802.11u GAS is the part of the WiFi Direct specification that provides service discovery. Over 6000 devices have been WiFi Direct certified. Analysts expect that all personal computers (PCs) and all smart phones will support WiFi Direct by 2014. The WiFi Alliance has Task Groups working on service discovery for wireless display (WiDi), printing, file transfer, Digital Living Network Alliance (DLNA), Universal Serial Bus (USB), docking, and social WiFi. This shows the impact of IEEE 802.11u GAS on shipping devices based on IEEE 802.11/WFA standards.

IEEE 802.11u specification provides over-the-air transportation for frames of higher-layer advertisements between WiFi Stations (802.11 enabled wireless stations or STAs) or between a server in an external network and an STA. GAS may be used prior to stations being associated to a wireless Access Point (AP) in a basic service set (BSS). Additionally, GAS supports higher layer protocols that employ a query/response mechanism. GAS defines a generic container to advertise network services information over an IEEE 802.11 network. Public Action frames are used to transport this information.

In a typical network, each STA associates with at least one AP to associate with the network to which the AP is connected. Associating with the AP includes, but is not limited to, establishing a connection between the STA and the AP, getting authorized by the AP and the network and gaining access to resources that are available via the network connection. Once associated with an AP, an STA can transmit and/or receive data using these network resources.

Pre-association exchange of information enables: (i) support for more informed decision making about an IEEE 802.11 infrastructure with which to associate; (ii) querying multiple networks in parallels; and (iii) an STA to discover information about APs that are not part of the same administrative group as the AP with which it is associated, thereby supporting the selection of an AP belonging to a different IEEE 802.11 infrastructure that has an appropriate subscription service provider (SSP) roaming agreement in place.

As used herein, a wireless station (STA) refers to any wireless device that contains an IEEE 802.11-conformant medium access control (MAC) and physical layer (PHY) interface to the wireless medium. A wireless station may be a fixed or portable. A mobile or portable STA may be, for example, a laptop, a tablet computer, a smartphone, and the like. A fixed STA may include, but is not limited to, a desktop, a workstation, an access point, a router, and the like.

As used herein, the term “access point” (AP) means any component, device, feature, element, or function that is configured to receive/transmit wireless traffic from a wireless client device in a wireless network. Typically, an access point or an access point device refers to a hardware component that includes a radio module, memory, processing logic, and a network communication module that enables it to communicate with other network architecture components. Additionally, it is contemplated that an access point may refer a subsystem that includes an access port device and a wireless switch. It is further contemplated that the term “access point” includes any individual component, device, hardware, or system, and any combination thereof, that is configured to function in the manner described herein. In various embodiments, an AP may have a station (STA) functionality and provides access to the distribution services, via the wireless medium for associated STAs.

A processor, as used herein, refers to a general-purpose or a specific-purpose processing device and/or logic as may be understood by one of ordinary skill in the art. A processor may, in various embodiments, include, but is not limited to, microprocessor, microcontroller, reduced instruction set circuits (RISC), application specific integrated circuit (ASIC), logic circuit, central processing unit, parent processing unit, graphical processor, signal processor, and the like. It is to be understood that the term “processor” may refer to more than one processing device and that various elements associated with a processing device (e.g., memory) may be shared by other processing devices.

As used herein, a transceiver refers to a device having a receiver, a transmitter and related electronic circuitry that enable the device to send and/or receive electromagnetic signals.

As used herein, a frame refers to a unit of data sent over a wireless communication channel. A beacon (or a beacon frame) is one of the management frames in IEEE 802.11 based Wireless Local Area Networks (WLANs). It contains all the information about the network. Beacon frames are transmitted periodically to announce the presence of a Wireless LAN network. Beacon frames are transmitted by the Access Point (AP) in an infrastructure Basic Service Set (BSS). In independent BSS (IBSS) network beacon generation is distributed among the stations. For example, a Beacon frame can include a MAC header, Frame body and Frame Check Sequence and have fields including a timestamp field, a beacon interval field which is a time-interval between beacon transmissions, and capability information field which can span 16 bits and contain information about capability of the device/network. Beacon transmissions, in some embodiments, may also include LBA related information such as, for example, venue type.

A scan request refers to a management frame in IEEE 802.11 based WLANs that is transmitted by a STA attempting to quickly locate a WLAN. A scan request may be used to locate IBSSs, BSSs, or mesh basic service sets (MBSSs) only or any of them. It may also be used to locate a WLAN with a particular SSID or to locate any WLAN. The scan request frame may contain an LBA service attribute request. A scan response refers to a frame sent back by a wireless device that meets the conditions set by a received scan request and may contain a timestamp, beacon interval and capability information. It may also include the SSID of the BSS, supported rates, PHY parameters, and the like. A probe request, or a probe, as used herein refers to a frame sent by a STA when it requires information from another station or access point. Likewise, a probe response refers to a frame sent from an access point containing information such as, for example, capability information, supported data rates, etc., after receiving a probe request.

A query request (interchangeably referred to as query) refers to a frame containing information that is requested by a STA. A query may include any information that a user of the STA seeks. For example, a user using applications related to location based advertising, the query may include a request for information about presence and location of a business in an area (e.g., food court in a shopping mall), location of a desired entity in a particular store, map of a shopping mall, information about a tourist site, discount deals available for stores or businesses in an area, and the like. In various embodiments, the STA may transmit the query to an AP which may relay the query to a server providing related services.

A request or a response, in various embodiments may be sent in pre-associated state or post-associated state by the STAs using public action frames in a unicast mechanism, a multicast mechanism or a broadcast mechanism. Unicast refers to transmission of messages or frames to a single network destination identified by a unique address. Multicast refers to transmission of messages or frames to a group of network destinations each identified by a unique address or a pre-determined attribute, e.g. within a specified subnet. Broadcast refers to transmission of messages or frames that will be received by every device within the range of the device or station that is sending the broadcast message or frame.

A server, as used herein, refers to a system that response to requests across a network to provide, or help to provide, a service. Examples of servers include, but are not limited to, database server, file server, mail server, printer server, web server, gaming server, application server, location based advertising server, and the like. Typically, a server can be run on a computer or a network of computers. A computer or network or computers can provide several services, and thus can have several servers running.

Various embodiments disclosed herein describe devices, methods and systems for enabling location based advertisement services without a device having to associate to WiFi network(s). In one embodiment, a wireless station (STA) including a processor, a memory, and one or more transceivers, is configured to send a probe request to one or more access points (APs) explicitly specifying support for location based advertisement (LBA). In one embodiment, the STA is adapted to transmit and/or receive frames supported by Institute of Electrical and Electronics Engineers' (IEEE's) 802.11u Generic Advertisement Service (GAS) specification. In some embodiments, the AP may be configured to communicate with a server adapted to provide LBA services.

In an embodiment, the STA is adapted to support a protocol that supports pre-association exchange of frames. In some embodiments, the STA supports the IEEE 802.11u GAS specification or similar protocols that enable pre-association exchange of frames. Frames exchanged prior to the STA being associated with the AP may include, for example, probe request frame, probe response frame, beacon frame, frames containing information specifying e.g., network access type (e.g., private, free public, for-free public), or venue information, frames containing metadata useful for network selection, query frame, query response frame, and so forth. In some embodiments, a scan frame transmitted by the STA may include information explicitly advertising the support for LBA services and/or pre-association exchange of frames. Likewise, in some embodiments, a beacon frame transmitted by the AP may include information explicitly advertising the support for LBA services and/or pre-association exchange of frames.

In various embodiments, in pre-associated or post-associate states, the STA may send a query request as a unicast frame wherein the STA sends a request to each AP individually. In some embodiments, in pre-associated or post-associate states, the STA may send the query request as a multicast frame to a group of APs. In other embodiments, in pre-associated or post-associate states, the STA may broadcast the query request to all LBA enabled APs. It is contemplated that the particular mechanism used by the STA for sending the query request will depend on the particular implementation and deployment. Factors such as, for example, cost, range, device diversity, network traffic, geographical area, power requirements and/or constraints, and the like may be used to make decisions regarding the deployment and implementation. Likewise, an AP may transmit a response to a query request using a in pre-associated or post-associate unicast, a multicast or a broadcast frame mechanism when a response becomes available to the AP.

The STA, in some embodiments, may pre-define a time at which the STA retrieves a response to a query request from the AP. For example, an STA could set up a timer to comeback to AP and at the expiration of timer, the STA could retrieve the response from the AP. Alternatively, in other embodiments, the STA and the AP could choose any alternative method using which the AP can transmit the response to the STA when a response to the query request is ready with the AP. One skilled in the art will be able to contemplate a desirable behavior for retrieval of response depending on a preferable deployment or implementation.

In an embodiment, the AP is configured to communicate with a server adapted to provide LBA services. When the STA sends a query to the AP, the AP relays the query to the server. The server analyzes the query and responds to it by sending query response to the AP that relayed the query. The AP then passes the response along to the STA. It is contemplated that the LBA server may respond to the query if it meets the specified request. Alternatively, the server may choose to ignore it if it does not have a matching response. As part of the response the server, in various embodiments, may send advertising material such as, for example, coupons, product offers, information discount offers, daily specials, and the like.

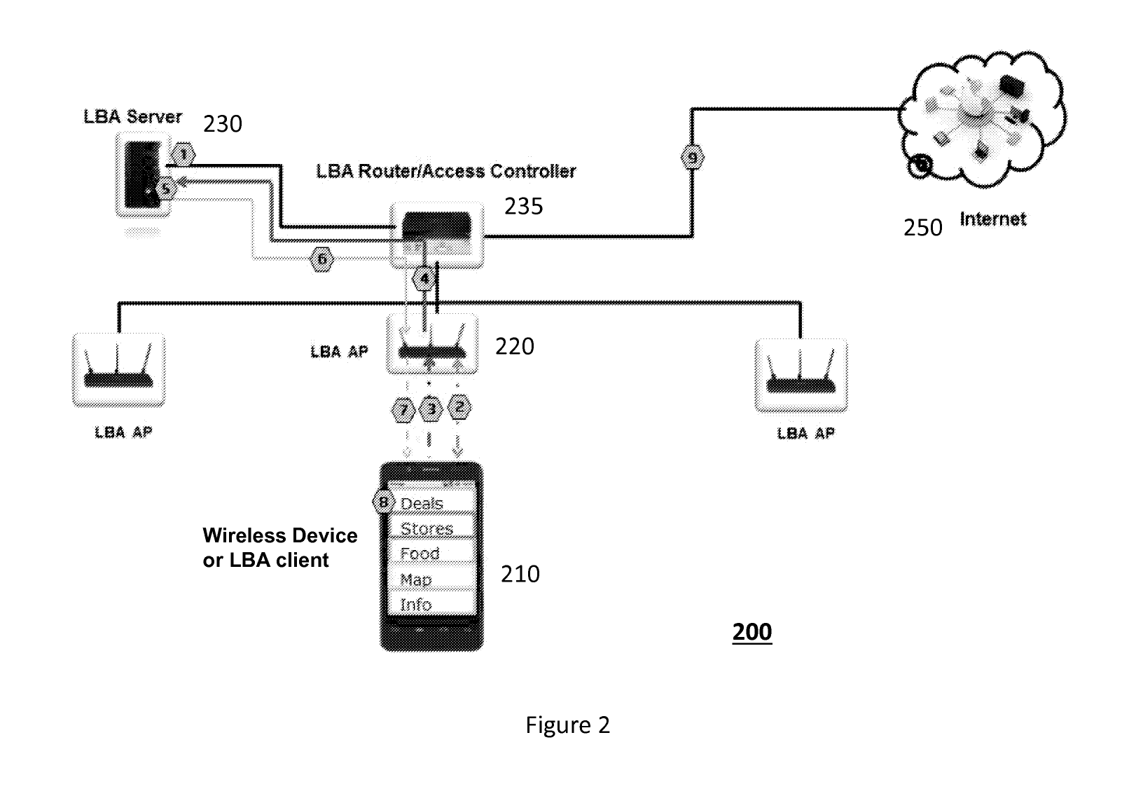

FIG. 2 depicts an illustrative schematic of an embodiment of a location based advertisement system in accordance with various aspects and principles of the present disclosure. The system 200 for providing location based advertisement services includes (i) a wireless station (STA) 210 having a processor, a memory and one or more transceivers, the STA configured to send a query request to one or more access points (APs) explicitly specifying support for location based advertisement (LBA); (ii) one or more APs 220, each enabled to advertise LBA support, and configured to communicate with one or more STAs and one or more servers; and (iii) one or more servers 230 providing LBA services, the one or more servers configured to communicate with the one or more APs. The system may further include a LBA access controller 235 for connecting the one or more servers 230. LBA access controller 235, in some embodiments, may be a wireless or a wired router for routing LBA information data packets between server(s) 230 and AP(s) 220.

In one embodiment, STA 210 and the one or more APs 220 are adapted to transmit and/or receive frames supported by IEEE 802.11u GAS specification or similar protocols that enable pre-associated frame exchange between STA and AP. In other embodiments, STA 210 and AP(s) 220 are adapted to wirelessly transmit and/or receive frames using a protocol that supports pre-association exchange of frames. Frames exchanged prior to STA 210 being associated with AP 220 may include, for example, probe request frame, probe response frame, beacon frame, frames containing information specifying e.g., network access type (e.g., private, free public, for-free public), or venue information, frames containing metadata useful for network selection, query frame, query response frame, and so forth.

In various embodiments, STA 210 may send a query request as a unicast frame. In other embodiments, STA 210 may send the query request as a multicast frame to a group of APs 220. In yet other embodiments, STA 210 may broadcast the query request to all LBA enabled APs. It is contemplated that a particular STA may use one or more of these mechanisms for sending the query request depending on implementation and deployment. Factors such as, for example, cost, range, device diversity, device density, network traffic, geographical area, power requirements and/or constraints, and the like may be used to make decisions regarding the deployment and implementation. Likewise, AP 220 may transmit a response to a query request using a unicast, a multicast or a broadcast mechanism when a response becomes available to AP 220.

STA 210, in some embodiments, may pre-define a time at which it retrieves a response to a query request from AP 220. For example, STA 210 could set up a timer to comeback to AP 220 and at the expiration of timer, STA 210 could retrieve the response from AP 220. Alternatively, in other embodiments, STA 210 and AP 220 could choose any alternative method using which AP 220 can transmit the response to STA 210 when a response to the query request is ready with AP 220. One skilled in the art will be able to contemplate a desirable behavior for retrieval of response depending on a preferable deployment or implementation.

In an embodiment, AP 220 is configured to communicate with server 230 adapted to provide LBA services. When STA 210 sends a query to AP 220, AP 220 relays the query to server 230. Server 230 analyzes the query and responds to it by sending query response to AP 220 that relayed the query. AP 220 then passes the response along to STA 210. It is contemplated that server 230 may respond to the query if it meets the specified request. Alternatively, the server may choose to ignore it if it does not have a matching response.

In various embodiments, the query may include, for example, a request for hyperlocal search or information about presence and location of a business in an area (e.g., food court in a shopping mall), location of a desired entity in a particular store, map of a shopping mall, information about a tourist site, discount deals available for stores or businesses in an area, and the like. As part of the response the server, in various embodiments, may send advertising material such as, for example, coupons, product offers, information discount offers, daily specials, and the like.

In some embodiments, AP 220 and server 230 may communicate through a router or access controller 235. Access controller 235 may connect multiple APs to server 220. In some embodiments, AP 220 may have to be authorized or authenticated before access controller 235 allows AP 220 to communicate with server 230.

In various embodiments, AP 220, upon receiving a response to a query from server 230, matches the response to the originating STA 210. It is to be noted that while the timing and mechanism of relaying the response to STA 210 will depend on deployment and implementation as described elsewhere herein, the response is relayed to STA 210 pre-association, i.e., STA 210 does not need to be associated to AP 220 for AP 220 to transmit a response frame to STA 210, or for STA 210 to receive the response frame from AP 220. In some embodiments, the pre-association communication between STA 210 and AP 220 may occur using IEEE 802.11u GAS as described elsewhere. In some embodiments, an alternative mechanism that makes available action/public action frames similar to IEEE 802.11u GAS may be used for the pre-association communication.

In an embodiment, referring to FIG. 2, a method for implementing location based advertisement services may include, initiating 2 discovery between a wireless station (STA) 210 and an access point (AP) 220 to identify support for location based advertisement (LBA) services, sending 3, from STA 210, a query request for LBA information to AP 220 using pre-association exchange frames, relaying 4 the query request to a LBA server 230, and analyzing 5, at server 230, the query request. STA 210 includes a processor, a memory, and one or more transceivers, and is configured to send a query request to one or more access points (APs) explicitly specifying support for location based advertisement (LBA).

In some embodiments, the method may further include transmitting 6, from server 230, a response to the query request to AP 220 and relaying 7 the response from AP 220 to STA 210 using pre-association exchange frames. In many embodiments, STA 210 may include an output device configured to display 8 the response received from the server.

STA 210 and the one or more APs are adapted to support a protocol that supports a pre-association exchange of frames. In some embodiments, STA 210 and/or the one or more APs support the IEEE 802.11u GAS specification for pre-association exchange of frames. Frames exchanged prior to STA 210 being associated with AP 220 may include, for example, probe request frame, probe response frame, beacon frame, frames containing information specifying e.g., network access type (e.g., private, free public, for-free public), or venue information, frames containing metadata useful for network selection, query frame, query response frame, and so forth.

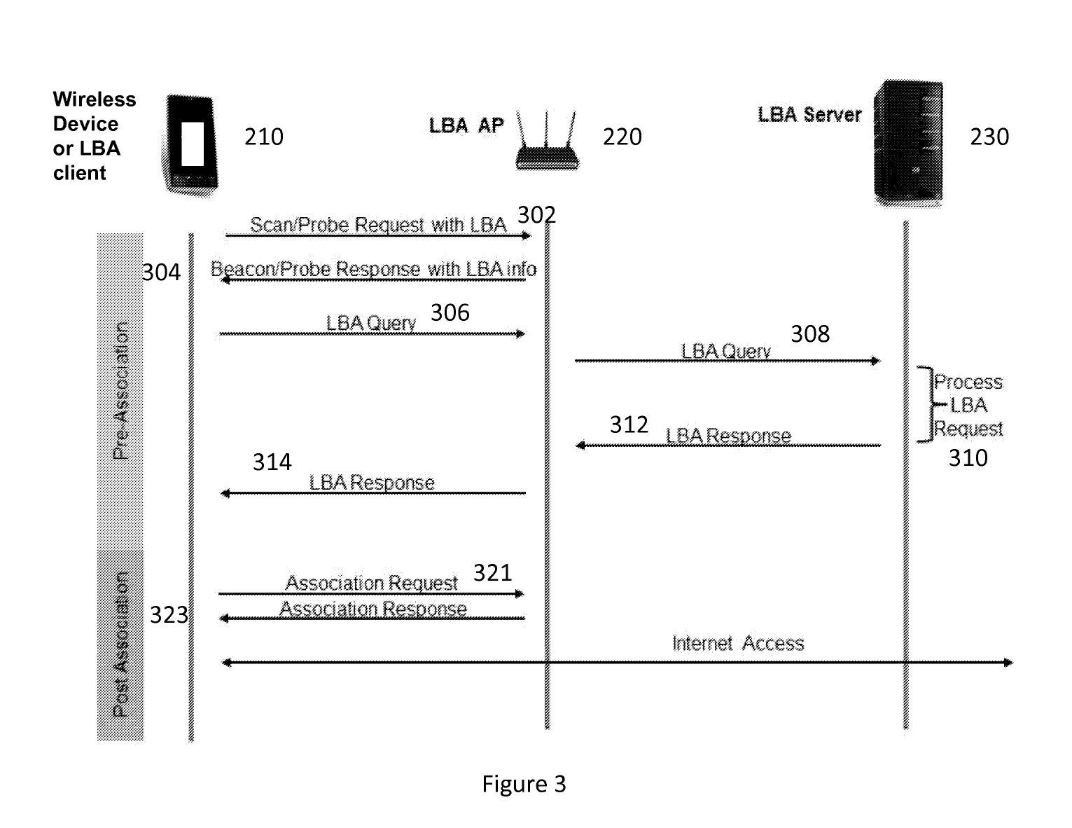

FIG. 3 an illustrative message flow in an embodiment of location based advertisement system in accordance with various aspects and principles of the present disclosure.

As shown in FIG. 3, message 302 comprises a scan request frame from STA 210 to AP 220. The scan frame may be used by STA 210 to initiate discovery of APs that support pre-association exchange of frames. Depending on the protocol being used, the scan frame may contain, e.g., information identifying STA 210 and other similar metadata. For example, in an embodiment, STA 210 may include explicitly advertised LBA capability and/or support for pre-association exchange of frames in a scan frame.

Upon receipt of scan message 302, AP 220 responds with message 304 having a beacon frame information identifying AP 220 and providing other metadata required by the protocol supported by STA 210 and AP 220. In some embodiments, AP 220 may use the beacon frame to advertise support for pre-association exchange of frames, or support for LBA services.

Once AP 220 and STA 210 have discovered each other, STA 210 transmits a probe request (also indicated by message 302). In some embodiments, probe is sent using a unicast frame to a single AP. In other embodiments, the probe request is sent using a multicast frame to a group of APs. In yet other embodiments, STA 210 may broadcast the probe request to all LBA enabled APs. It is contemplated that a particular STA may use one or more of these mechanisms for sending the probe request depending on implementation and deployment. STA 210 may use probe request to seek additional information about AP 220 or services provided by AP 220 (e.g, support for LBA services). For example, in an embodiment, STA 210 may explicitly advertise LBA capability and/or support for pre-association exchange of frames in a probe frame.

Upon receipt of the probe request, AP 220 responds with message 304 having a probe response frame containing information requested by STA 210. Additionally, the probe response frame indicates to STA 210 that AP 220 supports LBA services. In some embodiments, AP 220 may advertise other services over the probe response. For example, AP 220 may explicitly advertise support for LBA services and/or pre-association exchange of frames in a probe response frame. A connection is established between STA 210 and AP 220 upon receipt of the probe response.

Once STA 210 and AP 220 are able to communicate with each other, STA 210 transmits, using message 306, a query request to AP 220. In various embodiments, the query may include LBA information, for example, a request for information about presence and location of a business in an area (e.g., food court in a shopping mall), location of a desired entity in a particular store, map of a shopping mall, information about a tourist site, discount deals available for stores or businesses in an area, and the like. It is to be noted that STA 210 transmits the query request message 306 pre-association, i.e., it is not necessary for STA 210 or AP 220 to authenticate each other to exchange the query frames (query request and/or query response).

Upon receipt of the query, AP 220 relays, over message 308, the query to server 230 configured to provide LBA services. At block 310, server 230 processes the LBA query and to determine if server 230 is able to meet the request. In some embodiments, server 230 may determine that it cannot meet the request, for example, if the requested information is not found on server 230, or if the query is not a proper LBA query. In such embodiments, server 230 may choose to ignore the query request.

If server 230 determines that the request can be met, the server may choose to respond, over message 312 communicate the LBA response to AP 220. The response, in various embodiments, may include, for example, maps, coupons, product offers, service offers, product and/or service information, discount offers, daily specials, and the like.

Upon receipt of message 312 containing the query response, AP 220 matches the response to STA 210 which transmitted the query and relays the query response to STA 210 over message 314. STA 210 may then indicate the response to a user, for example, by using a display device built into STA 210.

In some embodiments, a provider of the LBA services or a host of the LBA server may choose to provide more detailed information to the user of STA 210. For example, the provider may provide a link to a webpage for more information about a product being advertised, or a service of interest to the user. In such embodiments, if the user selects to get more information through the provider's webpage, STA 210 may associate to the network and access the internet. STA 210 then sends an association request over message 321 and AP 220 responds with an association response over message 323.

Alternatively, the user may access internet using other connections available to the STA such as, for example, 3G, 4G, LTE, WiMax or any other alternative connection to access the internet.

Another embodiment is implemented as a program product for implementing systems and methods described herein. Some embodiments can take the form of an entirely hardware embodiment, an entirely software embodiment, or an embodiment containing both hardware and software elements. Some embodiments may be implemented in software, which includes but is not limited to firmware, resident software, microcode, etc.

Furthermore, embodiments can take the form of a computer program product (or machine-accessible product) accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product.

Embodiments within the scope of the present disclosure may further include computer-readable media for carrying or having computer-executable instructions or data structures stored thereon. Such computer-readable media can be any available media that can be accessed by a general purpose or a special purpose computer. Such computer-readable media may include, but are not limited to, RAM, ROM, EEPROM, CD-ROM, or other optical disk storage, magnetic disk storage, or other magnetic storage devices, or any other medium which can be used to carry or store desired program code means in the form of computer-executable instructions or data structures. When information is transferred or provided over a network or another communications connection (either hardwired, wireless or a combination thereof) to a computer, the computer properly views the connection as a computer-readable medium. Thus, any such connection is properly termed as computer-readable medium. Combinations of the above should also be included within the scope of the computer-readable media.

Computer-executable instructions include, but are not limited to, instructions and data which cause a general purpose computer, a special purpose computer, or a special purpose processing device to perform a certain function or a group of functions. Computer-executable instructions also include program modules that are executed by computers in stand-alone or network environments. Generally, program modules include routines, programs, objects, components, data structures, and the like, that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

Having thus described the basic concepts, it will be rather apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of processing elements or sequences, or the use of numbers, letters, or other designations therefore, is not intended to limit the claimed processes and methods to any order except as can be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, as the following claims reflect, inventive embodiments lie in less than all features of a single foregoing disclosed embodiment. Thus, the claims following the detailed description are hereby expressly incorporated into this detailed description.

### EXAMPLES

The following examples highlight non-limiting characteristics and attributes of the various and principles of the present disclosure:

Example 1 is a wireless device (STA) including a processor, a memory, and one or more transceivers, the STA configured to send a query request to one or more access points (APs) explicitly specifying support for location based advertisement (LBA).

Example 2 is the wireless device of example 1, wherein the STA is adapted to support a protocol that supports a pre-association or post-association exchange of frames.

Example 3 is the wireless device of any one of examples 1-2, wherein the STA is adapted to transmit and/or receive frames supported by Institute of Electrical and Electronics Engineers' (IEEE's) 802.11u Generic Advertisement Service (GAS) specification.

Example 4 is the wireless device of any one of examples 1-3, wherein the query request is one or more of a unicast frame, a multicast frame, or a broadcast frame.

Example 5 is the wireless device of any one of examples 1-4, wherein the STA pre-defines a time at which the STA retrieves a response to the query request from the AP.

Example 6 is the wireless device of any one of examples 1-5, wherein the AP transmits a response to the query request when the response becomes available to the AP.

Example 7 is the wireless device of example 6, wherein the response to the query request is transmitted as one or more of a unicast frame, a multicast frame, or a broadcast frame.

Example 8 is the wireless device of any one of examples 1-7, wherein the AP is configured to communicate with a server adapted to provide LBA services.

Example 9 is a system including a wireless device (STA) including a processor, a memory and one or more transceivers, the STA configured to send a query request to one or more access points (APs) explicitly specifying support for location based advertisement (LBA). The system further includes one or more APs, each enabled to advertise LBA support, and configured to communicate with one or more STAs and one or more servers, and one or more servers providing LBA services, the one or more servers configured to communicate with the one or more APs.

Example 10 is the system of example 9, wherein the STA is adapted to support a protocol that supports a pre-association or post-association exchange of frames.

Example 11 is the system of any one of examples 9-10, wherein the STA and the one or more APs are adapted to transmit and/or receive frames supported by Institute of Electrical and Electronics Engineers' (IEEE's) 802.11u Generic Advertisement Service (GAS) specification.

Example 12 is the system of any one of examples 9-10, wherein the query request is one or more of a unicast frame, a multicast frame, or a broadcast frame.

Example 13 is the system of any one of examples 9-12, wherein the one or more APs are adapted to relay query requests from the STA to the one or more servers.

Example 14 is the system of any one of examples 9-13, wherein the one or more APs are adapted to relay a response from one or more servers to the STA.

Example 15 is the system of any one of examples 9-14, wherein the one or more servers are adapted to store LBA content.

Example 16 is the system of any one of examples 9-15, wherein the one or more servers are adapted to process and/or respond to LBA query requests received from the one or more APs and/or the STA.

Example 17 is a method of implementing location based advertisement (LBA) services. The method includes initiating discovery between a wireless device (STA) and an access point (AP) to identify support for location based advertisement (LBA) services, transmitting, from the STA, a query request for LBA information to the AP using pre-association exchange frames, relaying the query request to a LBA server, and analyzing, at the server, the query request. The STA includes a processor, a memory, and one or more transceivers, and is configured to send a query request to one or more access points (APs) explicitly specifying support for location based advertisement (LBA).

Example 18 is the method of example 17, further comprising transmitting, from the server, a response to the query request to the AP and relaying the response from the AP to the STA using pre-association exchange frames.

Example 19 is the method of any one of examples 17-18, wherein the STA is adapted to support a protocol that supports a pre-association exchange of frames.

Example 20 is the method of any one of examples 17-19, wherein the STA is adapted to transmit and/or receive frames supported by Institute of Electrical and Electronics Engineers' (IEEE's) 802.11u Generic Advertisement Service (GAS) specification.

Example 21 is the method of any one of examples 17-20, wherein sending the query request for LBA information includes transmitting the probe request as one or more of a unicast frame, a multicast frame, or a broadcast frame.

Example 22 is the method of any one of examples 17-21, wherein the STA pre-defines a time at which the STA retrieves a response to the query request from the AP.

Example 23 is a computer-readable medium comprising computer-readable code physically embodied thereon which, when executed by a processor, causes the processor to perform a method of any one of examples 17-22.

Example 24 is a computer-readable medium comprising computer-readable instructions to implement, when executed, the method of any one of examples 17-22.

Example 25 is an electronic device comprising means for performing a method of any one of examples 17-22.

Example 26 is the wireless device of example 1, wherein the STA is adapted to transmit and/or receive frames supported by Institute of Electrical and Electronics Engineers' (IEEE's) 802.11u Generic Advertisement Service (GAS) specification.

Example 27 is the wireless device of example 1, wherein the query request is one or more of a unicast frame, a multicast frame, or a broadcast frame.

Example 28 is the wireless device of example 1, wherein the STA pre-defines a time at which the STA retrieves a response to the query request from the AP.

Example 29 is the wireless device of example 1, wherein the AP transmits a response to the query request when the response becomes available to the AP.

Example 30 is the wireless device of example 6, wherein the response to the query request is transmitted as one or more of a unicast frame, a multicast frame, or a broadcast frame.

Example 31 is the wireless device of example 1, wherein the AP is configured to communicate with a server adapted to provide LBA services.

Example 32 is the system of example 9, wherein the STA and the one or more APs are adapted to transmit and/or receive frames supported by Institute of Electrical and Electronics Engineers' (IEEE's) 802.11u Generic Advertisement Service (GAS) specification.

Example 33 is the system of example 9, wherein the query request is one or more of a unicast frame, a multicast frame, or a broadcast frame.

Example 34 is the system of example 9, wherein the one or more servers are adapted to store LBA content.

Example 35 is the system of example 9, wherein the one or more servers are adapted to process and/or respond to LBA query requests received from the one or more APs and/or the STA.

Example 36 is the method of example 17, wherein the STA is adapted to support a protocol that supports a pre-association or post-association exchange of frames.

Example 37 is the method of example 17, wherein the STA is adapted to transmit and/or receive frames supported by Institute of Electrical and Electronics Engineers' (IEEE's) 802.11u Generic Advertisement Service (GAS) specification.

Example 38 is the method of example 17, wherein the STA pre-defines a time at which the STA retrieves a response to the query request from the AP.

Example 39 is a computer-readable medium comprising computer-readable code physically embodied thereon which, when executed by a processor, causes the processor to perform a method of example 17.

Example 40 is an electronic device comprising means for performing a method of any one of examples 17-22.

Example 41 is a system comprising at least one electronic device comprising a processor, in communication with a memory, for executing instructions to perform a method of any one of claims 17-22.

Example 42 is a computer-readable medium comprising computer-readable instructions to implement, when executed, the method of any one of examples 17-22.

Example 43 is a computer program product comprising a computer-readable medium having computer program logic recorded thereon arranged to execute the method of any one of examples 17-22.

1-25. (canceled)

26. A wireless device comprising a processor, a memory, and one or more transceivers, wherein the wireless device is configured to send a query request to one or more access points (APs) explicitly specifying support for location based advertisement (LBA).

27. The wireless device of claim 26, wherein the wireless device is adapted to support a protocol that supports a pre-association exchange of frames.

28. The wireless device of claim 26, wherein the wireless device is adapted to transmit and/or receive frames supported by Institute of Electrical and Electronics Engineers' (IEEE's) 802.11u Generic Advertisement Service (GAS) specification.

29. The wireless device of claim 26, wherein the query request is one or more of a unicast frame, a multicast frame, or a broadcast frame.

30. The wireless device of claim 26, wherein the wireless device pre-defines a time at which the wireless device retrieves a response to the query request from the AP.

31. The wireless device of claim 26, wherein the AP transmits a response to the query request when the response becomes available to the AP.

32. The wireless device of claim 26, wherein the response to the query request is transmitted as one or more of a unicast frame, a multicast frame, or a broadcast frame.

33. The wireless device of claim 26, wherein the AP is configured to communicate with a server adapted to provide LBA services.

34. A system comprising:
a wireless device comprising a processor, a memory and one or more transceivers, the wireless device being configured to send a query request to one or more access points (APs) explicitly specifying support for location based advertisement (LBA);
one or more APs, each enabled to advertise LBA support, and configured to communicate with one or more STAs and one or more servers; and
one or more servers providing LBA services, the one or more servers being configured to communicate with the one or more APs.

35. The system of claim 34, wherein the wireless device is adapted to support a protocol that supports a pre-association exchange of frames.

36. The system of claim 34, wherein the wireless device and the one or more APs are adapted to transmit and/or receive frames supported by Institute of Electrical and Electronics Engineers' (IEEE's) 802.11u Generic Advertisement Service (GAS) specification.

37. The system of claim 34, wherein the query request is one or more of a unicast frame, a multicast frame, or a broadcast frame.

38. The system of claim 34, wherein the one or more servers are adapted to store LBA content.

39. The system of claim 34, wherein the one or more servers are adapted to process and/or respond to LBA query requests received from the one or more APs and/or the wireless device.

40. A method of implementing location based advertisement (LBA) services, the method comprising:
initiating discovery between a wireless device and an access point (AP) to identify support for location based advertisement (LBA) services;
transmitting, from the wireless device, a query request for LBA information to the AP using pre-association exchange frames;
relaying the query request to a LBA server; and
analyzing, at the server, the query request,
wherein the wireless device includes a processor, a memory, and one or more transceivers, and is configured to send a query request to one or more access points (APs) explicitly specifying support for location based advertisement (LBA).

41. The method of claim 40, further comprising transmitting, from the server, a response to the query request to the AP and relaying the response from the AP to the wireless device using pre-association exchange frames.

42. The method of claim 40, wherein the wireless device is adapted to support a protocol that supports a pre-association or post-association exchange of frames.

43. The method of claim 40, wherein the wireless device is adapted to transmit and/or receive frames supported by Institute of Electrical and Electronics Engineers' (IEEE's) 802.11u Generic Advertisement Service (GAS) specification.

44. The method of claim 40, wherein the wireless device pre-defines a time at which the wireless device retrieves a response to the query request from the AP.

45. A computer-readable medium comprising computer-readable code physically embodied thereon which, when executed by a processor, causes the processor to perform a method of claim 40.
